(19) United States
(12) Patent Application Publication
(10) Pub. No.: US 2026/0025047 A1
(43) Pub. Date: Jan. 22, 2026

(54) ELECTRIC WORK MACHINE

(71) Applicant: MAKITA CORPORATION, Anjo-shi (JP)

(72) Inventors: Yosuke SAKAMOTO, Anjo-shi (JP); Kisho SEKIDO, Anjo-shi (JP)

(73) Assignee: MAKITA CORPORATION, Anjo-shi (JP)

(21) Appl. No.: 19/272,594

(22) Filed: Jul. 17, 2025

(30) Foreign Application Priority Data
Jul. 19, 2024 (JP) 2024-116009

(51) Int. Cl. H02K 11/00; H02K 7/14; H02K 11/21; H02K 11/28; H02K 11/33; H02P 6/08

(52) U.S. Cl. CPC H02K 11/0094; H02K 7/145; H02K 11/21; H02K 11/28; H02K 11/33; H02P 6/08; H02K 2211/03

(57) ABSTRACT

One aspect of the present disclosure provides an electric work machine including a motor, an operable component, a controller, a signal line, a position detector, a pull-up resistor, and a pull-down resistor. In the position detector, a first output terminal of a first sensor is coupled to the signal line through a first resistor, and a second output terminal of a second sensor is coupled to the signal line through a second resistor coupled in parallel with the first resistor. The pull-up resistor is provided in the electric work machine to pull up the signal line to a preset power-supply voltage. The pull-down resistor is provided in the electric work machine to pull down the signal line to a preset reference potential.

### CROSS-REFERENCE TO RELATED APPLICATIONS

This application claims the benefit of Japanese Patent Application No. 2024-116009 filed on Jul. 19, 2024 with the Japan Patent Office, the entire disclosure of which is incorporated herein by reference.

### BACKGROUND

The present disclosure relates to an electric work machine.

Japanese Unexamined Patent Application Publication No. 2023-125807 discloses a driver drill that includes a controller board and a mode sensor board.

The controller board includes a motor control circuit. The mode sensor board includes a speed mode detection circuit, an input terminal, and an output terminal.

The speed mode detection circuit detects a speed mode of a reducer in the driver drill by detecting a position of a speed switch lever. The input terminal and the output terminal are coupled to the speed mode detection circuit. The controller board applies a voltage to the speed mode detection circuit through an input lead wire and the input terminal. An output signal from the speed mode detection circuit is transmitted to the controller board through the output terminal and an output lead wire.

The speed mode detection circuit includes a first mode sensor and a second mode sensor. The first mode sensor and the second mode sensor are coupled in parallel with each other to the input terminal. The first mode sensor includes a ground port that is coupled to the output terminal via a signal line. The signal line is coupled to the input terminal via a resistor R1. The second mode sensor includes a ground port that is coupled to the signal line via a resistor R2.

The mode sensor board configured in this manner outputs: (i) an output signal at an L level in response to the speed switch lever being at a first position; (ii) an output signal at a H level in response to the speed switch lever being at a second position; and (iii) an output signal at a level of [R2/(R1+R2)×H] in response to the speed switch lever being at a third position.

### SUMMARY

In the driver drill configured as described above, there may be cases in which the trace on the controller board that receives the output signal from the speed mode detection circuit is (i) pulled down to the ground through a pull-down resistor on the controller board, or (ii) pulled up to the voltage through a pull-up resistor on the controller board. In such cases, when the output lead wire becomes disconnected, a voltage level of the trace on the controller board may be fixed at the L level or the H level, causing a circuit on the controller board to erroneously determine that the speed switch lever is at the first position or the second position even though the speed switch lever is at the third position.

In one aspect of the present disclosure, it is desirable to provide an electric work machine configured such that a voltage level of a detection signal received at a controller through a signal line between a position detector and the controller is distinguishable from the voltage level received in the event of a disconnection of the signal line.

In the present disclosure, it should be noted that the terms such as “first” and “second” are intended simply to distinguish elements from each other, and are not intended to limit the order or the number of the elements. The first element may be referred to as the second element, and similarly, the second element may be referred to as the first element. In addition, the first element may be included without the second element, and similarly, the second element may be included without the first element.

One aspect of the present disclosure provides an electric work machine including a motor, an operable component, a controller, a signal line, a position detector, a pull-up resistor, and a pull-down resistor.

The motor is configured to drive a tool. The operable component is configured to be manually moved by a user of the electric work machine to switch operating modes of the motor. The controller is configured (i) to receive a detection signal, and (ii) to switch the operating modes of the motor in response to a voltage level of the detection signal. The signal line is coupled to the controller. The position detector is (i) coupled to the signal line, and (ii) configured to output the detection signal to the controller through the signal line.

The position detector includes a first resistor, a second resistor, a first sensor, and a second sensor.

The first resistor (i) has a first resistance value and (ii) is coupled to the signal line. The second resistor (i) is distinct from the first resistor, (ii) has a second resistance value that is different from the first resistance value, and (iii) is coupled to the signal line in parallel with the first resistor.

The first sensor includes a first output terminal. The first sensor is configured (i) to set the first output terminal to a first voltage level in response to the operable component being positioned at a first position, and (ii) to set the first output terminal to a second voltage level in response to the operable component being displaced from the first position. The first output terminal is coupled to the signal line through the first resistor. The first voltage level is comparable to either (i) a preset reference potential, or (ii) a preset power-supply voltage that is higher than the preset reference potential. The second voltage level is the inverse of the first voltage level.

The second sensor (i) is distinct from the first sensor, and (ii) includes a second output terminal. The second sensor is configured (i) to set the second output terminal to the first voltage level in response to the operable component being positioned at the second position, and (ii) to set the second output terminal to the second voltage level in response to the operable component being displaced from the second position. The second output terminal is coupled to the signal line through the second resistor. The second position is distinct from the first position.

The pull-up resistor is provided in the electric work machine to pull up the signal line to the preset power-supply voltage. The pull-down resistor is provided in the electric work machine to pull down the signal line to the preset reference potential.

In the electric work machine configured as described above, an electric current flows through the first resistor or the second resistor in response to the operable component being positioned at the first position or the second position. As a result, the detection signal with a divided voltage appears on the signal line. Specifically, the divided voltage is generated by dividing the preset power-supply voltage using (i) the pull-up resistor, and (ii) an equivalent resistor of the pull-down resistor and either the first resistor or the second resistor. Since the first resistance value of the first resistor and the second resistance value of the second resistor are different from each other, the divided voltage at the time of the operable component being positioned at the first position differs in magnitude from the divided voltage at the time of the operable component being positioned at the second position. Furthermore, these divided voltages differ in magnitude from both the preset power-supply voltage and the preset reference potential.

When the signal line becomes disconnected, the voltage level of the detection signal received at the controller may be set, by the pull-down resistor or the pull-up resistor, to a voltage level comparable to either the preset reference potential or the preset power-supply voltage.

Thus, in this electric work machine, it is possible that the voltage level of the detection signal received at the controller through the signal line between the position detector and the controller is distinguishable from the voltage level received in the event of a disconnection of the signal line.

### BRIEF DESCRIPTION OF THE DRAWINGS

Example embodiments of the present disclosure will be described hereinafter with reference to the accompanying drawings, in which:

FIG. 1 is an external view of an electric work machine;

FIG. 2 is a central longitudinal cross-sectional view of the electric work machine;

FIG. 3 is a block diagram showing an electrical configuration of the electric work machine;

FIG. 4 illustrates a mechanical structure and operation of a position detector in a first embodiment;

FIG. 5 is a circuit diagram showing a circuit configuration on a sensor board and a part of a circuit configuration on a controller board in the first embodiment;

FIG. 6A is an explanatory table describing operations in position detections in the first embodiment;

FIG. 6B is an explanatory diagram showing speed mode determination thresholds used in a control circuit in the first embodiment;

FIG. 7 is a flowchart of a control process executed in the control circuit in the first embodiment;

FIG. 8 is a flowchart of a first speed mode detection process executed in the control circuit in the first embodiment;

FIG. 9 illustrates a mechanical structure and operation of a position detector in a second embodiment;

FIG. 10 is a circuit diagram showing a circuit configuration on a sensor board and a part of a circuit configuration on a controller board in the second embodiment;

FIG. 11A is an explanatory table describing operations in position detections in the second embodiment;

FIG. 11B is an explanatory diagram showing speed mode determination thresholds used in a control circuit in the second embodiment;

FIG. 12 is a flowchart of a second speed mode detection process executed in the control circuit in the second embodiment;

FIG. 13 is a circuit diagram showing a circuit configuration on a sensor board and a part of a circuit configuration on a controller board in a third embodiment;

FIG. 14A is an explanatory table describing operations in position detections in the third embodiment;

FIG. 14B is an explanatory diagram showing speed mode determination thresholds used in a control circuit in the third embodiment;

FIG. 15 illustrates a mechanical structure and operation of a position detector in a fourth embodiment;

FIG. 16 is a circuit diagram showing a circuit configuration on a sensor board and a part of a circuit configuration on a controller board in the fourth embodiment;

FIG. 17A is an explanatory table describing operations in position detections in the fourth embodiment; and

FIG. 17B is an explanatory diagram showing speed mode determination thresholds used in a control circuit in the fourth embodiment.

### DETAILED DESCRIPTION OF EXEMPLARY EMBODIMENTS

### 1. Overview of Embodiments

One embodiment may provide an electric work machine including at least any one of:
Feature 1: a motor configured to drive a tool;
Feature 2: an operable component configured to be manually moved by a user of the electric work machine to switch operating modes of the motor;
Feature 3: a controller configured (i) to receive a detection signal, and (ii) to switch the operating modes of the motor in response to a voltage level of the detection signal;
Feature 4: a signal line (or a signal wiring, or a signal cable, or a lead wire) coupled to (or connected to) the controller;
Feature 5: a position detector (i) coupled to the signal line, and (ii) configured to output the detection signal to the controller through the signal line;
Feature 6: the position detector includes a first resistor (i) having a first resistance value, and (ii) coupled to (or connected to) the signal line;
Feature 7: the position detector includes a second resistor (i) distinct from the first resistor, (ii) having a second resistance value that is different from the first resistance value, and (iii) coupled to (or connected to) the signal line in parallel with the first resistor;
Feature 8: the position detector includes a first sensor including a first output terminal;
Feature 9: the first sensor is configured (i) to set the first output terminal to a first voltage level in response to the operable component being positioned at a first position, and (ii) to set the first output terminal to a second voltage level in response to the operable component being displaced (or deviated) from the first position;
Feature 10: the first output terminal is coupled to (or connected to) the signal line through the first resistor;
Feature 11: the first voltage level is comparable to (or equivalent to or corresponding to) either (i) a preset reference potential, or (ii) a preset power-supply voltage that is higher than the preset reference potential;
Feature 12: the second voltage level is the inverse of the first voltage level;
Feature 13: the position detector includes a second sensor (i) distinct from the first sensor, and (ii) including a second output terminal;
Feature 14: the second sensor is configured (i) to set the second output terminal to the first voltage level in response to the operable component being positioned at a second position, and (ii) to set the second output terminal to the second voltage level in response to the operable component being displaced (or deviated) from the second position;
Feature 15: the second output terminal is coupled to (or connected to) the signal line through the second resistor;
Feature 16: the second position is distinct from the first position;
Feature 17: a pull-up resistor provided in the electric work machine to pull up the signal line to the preset power-supply voltage; and
Feature 18: a pull-down resistor provided in the electric work machine to pull down the signal line to the preset reference potential.

In the electric work machine including at least Features 1 through 18, it is possible that the voltage level of the detection signal received at the controller through the signal line between the position detector and the controller is distinguishable from the voltage level received in the event of a disconnection of the signal line (or a break in the signal line).

The first voltage level or the second voltage level may be equal to the preset reference potential or may be close to (or in the vicinity of) the preset reference potential. Alternatively, the first voltage level or the second voltage level may be equal to the preset power-supply voltage or may be close to (or in the vicinity of) the preset power-supply voltage.

Examples of the tool include, but are not limited to, a tool bit, a tool tip, a fan, a reciprocating saw blade, a jigsaw blade, a chainsaw chain, a tipped saw blade (or a circular saw blade), a brush cutter blade, and a string trimmer head (e.g., a nylon cord trimmer head).

The operable component may be moved in any direction by the user. Specifically, the operable component may be moved, by the user, linearly and/or along a curved path. Additionally or alternatively, the operable component may be rotated by the user.

One embodiment may include, in addition to or in place of at least any one of Features 1 through 18,
Feature 19: the pull-up resistor and/or the pull-down resistor is provided in the controller.

In the electric work machine including at least Features 1 through 19, with (i) the pull-up resistor provided in the controller and (ii) the pull-down resistor provided in the position detector, the controller receives the detection signal with the voltage level comparable to the preset power-supply voltage in the event of a disconnection of the signal line.

On the other hand, with (i) the pull-up resistor provided in the position detector and (ii) the pull-down resistor provided in the controller, the controller receives the detection signal with the voltage level comparable to the preset reference potential in the event of a disconnection of the signal line.

Therefore, in the electric work machine configured as such, the controller can accurately detect a disconnection of the signal line.

The voltage level comparable to the preset power-supply voltage may be equal to the preset power-supply voltage or may be close to (or in the vicinity of) the preset power-supply voltage.

The voltage level comparable to the preset reference potential may be equal to the preset reference potential or may be close to (or in the vicinity of) the preset reference potential.

One embodiment may include, in addition to or in place of at least any one of Features 1 through 19, at least any one of:
Feature 20: the pull-up resistor is provided in the controller, and
Feature 21: the pull-down resistor is provided in the position detector.

In the electric work machine including at least Features 1 through 21, the controller receives the detection signal with the voltage level comparable to the preset power-supply voltage in the event of a disconnection of the signal line. Accordingly, the controller can accurately detect a disconnection of the signal line. In addition, the voltage level of the detection signal is stabilized by the pull-up resistor, which helps suppress faulty operation of the controller caused by external noise.

One embodiment may include, in addition to or in place of at least any one of Features 1 through 21,
Feature 22: either the first resistance value or the second resistance value is zero ohms.

In the electric work machine including at least Features 1 through 22, an impedance of the position detector, as viewed from the controller, decreases, which helps suppress faulty operation of the controller caused by external noise.

One embodiment may include, in addition to or in place of at least any one of Features 1 through 22, at least any one of:
Feature 23: the pull-down resistor is provided in the position detector to couple to the preset reference potential through a semiconductor switch;
Feature 24: a power-supply line configured to supply the preset power-supply voltage from the controller to the first sensor and the second sensor;
Feature 25: the first sensor and the second sensor are configured to receive the preset power-supply voltage to operate; and
Feature 26: the semiconductor switch is configured to conduct in response the preset power-supply voltage being applied to the first sensor and the second sensor.

In the electric work machine including at least Features 1 through 21 and 23 through 26, the controller receives the detection signal with the voltage level comparable to the preset power-supply voltage in the event of a disconnection of the power-supply line. Accordingly, the controller can detect a disconnection of the power-supply line based on the voltage level of the detection signal.

Examples of the semiconductor switch include, but are not limited to, a bipolar transistor, a metal-oxide-semiconductor field-effect transistor (MOSFET), a junction field-effect transistor (JFET), and an insulated-gate bipolar transistor (IGBT).

One embodiment may include, in addition to or in place of at least any one of Features 1 through 26, at least any one of:
Feature 27: the pull-up resistor is provided in the position detector;
Feature 28: the pull-down resistor is provided in the controller; and
Feature 29: the controller is configured to receive the detection signal with the voltage level comparable to the preset power-supply voltage in response to (i) the signal line not being disconnected, and (ii) the operable component being displaced from both the first position and the second position.

In the electric work machine including at least Features 1 through 19 and 27 through 29, the voltage level of the detection signal is stabilized due to the pull-down resistor provided in the controller, which helps suppress faulty operation of the controller caused by external noise. The controller receives the detection signal with the voltage level comparable to the preset reference potential in the event of a disconnection of the signal line. Accordingly, the controller can accurately detect a disconnection of the signal line. In addition, the controller receives the detection signal with the voltage level comparable to the preset power-supply voltage in response to the operable component being displaced from the first position and the second position. Accordingly, the controller can detect the operable component positioned at an additional position that is displaced (or deviated) from both the first position and the second position and set the motor to an additional operating mode associated with the additional position.

One embodiment may include, in addition to or in place of at least any one of Features 1 through 29, at least any one of:
Feature 30: both the pull-up resistor and the pull-down resistor are provided in the controller; and
Feature 31: the controller is configured to receive the detection signal with the voltage level comparable to the preset power-supply voltage in response to the signal line being disconnected.

In the electric work machine including at least 1 through 19, 30, and 31, the number of components of the position detector can be reduced due to both the pull-up resistor and the pull-down resistor provided in the controller, which leads to a suppression of an increase in size of the position detector. Furthermore, the controller receives the detection signal with the voltage level comparable to the preset power-supply voltage in the event of a disconnection of the signal line. Accordingly, the controller can accurately detect a disconnection of the signal line.

One embodiment may include, in addition to or in place of at least any one of Features 1 through 31,
Feature 32: each of the first resistance value and the second resistance value is greater than zero ohms.

In the electric work machine including at least Features 1 through 19, 27, 28, and 32, or at least Features 1 through 19, 30, and 32, the controller does not receive the detection signal with the voltage level comparable to the preset reference potential in the event of no disconnection of the signal line, due to each of the first resistance value and the second resistance value greater than zero ohms. Accordingly, the detection signal with the voltage level comparable to the preset reference potential can be utilized for another purpose other than the position detection of the operable component. Examples of another purpose includes, but are not limited to, a detection of a disconnection of the signal line.

One embodiment may include, in addition to or in place of at least any one of Features 1 through 32, at least any one of:
Feature 33: the pull-up resistor is provided to directly couple to the preset power-supply voltage, and
Feature 34: the pull-down resistor is provided to directly couple to the preset reference potential.

In the electric work machine including at least Features 1 through 19, 27, 28, 33, and 34, or at least Features 1 through 19, 30, 33, and 34, the number of components for coupling (or connecting) the pull-up resistor to the preset power-supply voltage or for coupling (or connecting) the pull-down resistor to the preset reference potential can be reduced. In addition, the controller can detect a disconnection of the signal line.

One embodiment may include, in addition to or in place of at least any one of Features 1 through 34, at least any one of:
Feature 35: the pull-up resistor has a third resistance value;
Feature 36: the pull-down resistor has a fourth resistance value at least ten times greater than each of the first through third resistance values; and
Feature 37: the first resistance value, the second resistance value, and the third resistance value are in the ratio of 1:4:2.

In the electric work machine including at least Features 1 through 19, 27, 28, and 35 through 37, or at least Features 1 through 19, 30, and 35 through 37, the controller can receive the detection signal with the voltage level comparable to either (i) the preset power-supply voltage or (ii) the preset reference potential in the event of a disconnection of the signal line, without any influence to the voltage level of the detection signal when the operable component is at either the first position or the second position, which helps suppress faulty operation of the controller caused by external noise.

Furthermore, by setting the ratio between the first through third resistance values as mentioned above, the voltage level of the detection signal can change by a constant voltage interval in response to the operable component being moved from the first position to the second position and vice versa. As a result, the position of the operable component, as well as the operating mode selected can be accurately detected.

One embodiment may include, in addition to or in place of at least any one of Features 1 through 37, at least any one of:
Feature 38: the position detector includes a third resistor (i) distinct from both the first resistor and the second resistor, (ii) having a fifth resistance value that is different from both the first resistance value and the second resistance value, and (iii) coupled to (or connected to) the signal line in parallel with the first resistor and the second resistor; and
Feature 39: the position detector includes a third sensor (i) distinct from both the first sensor and the second sensor, and (ii) including a third output terminal;
Feature 40: the third sensor is configured (i) to set the third output terminal to the first voltage level in response to the operable component being positioned at a third position, and (ii) to set the third output terminal to the second voltage level in response to the operable component being displaced (or deviated) from the third position;
Feature 41: the third output terminal is coupled to (or connected to) the signal line through the third resistor; and
Feature 42: the third position is distinct from both the first position and the second position.

In the electric work machine including at least Features 1 through 12 and 38 through 42, the controller receives the detection signal with the voltage level that is different from the voltage level when the operable component is positioned at either the first position or the second position, in response to the operable component being positioned at the third position. As a result, the controller can detect the operable component positioned at the third position based on the voltage level of the detection signal.

Examples of the electric work machine include, but are not limited to, electric appliances configured to be used at job-sites, such as building sites, manufacturing sites, gardening sites, and construction sites, and specifically include, but are not limited to, power tools for masonry work, metalworking, and woodworking, power tools for gardening, and battery-powered wheel barrows. Examples of the power tools include, but are not limited to, an electric blower, an electric hammer, an electric hammer drills, an electric drill, an electric driver, an electric wrench, an electric grinder, an electric circular saw, an electric reciprocating saw, an electric jig saw, an electric cutter, an electric chain saw, an electric plane, an electric nailing machine (including tacker), an electric hedge trimmer, an electric lawn mower, an electric lawn trimmer, an electric bush/grass cutter, an electric cleaner, an electric sprayer, an electric spreader, an electric dust collector (or an electric dust extractor), an electric trowel, an electric vibrator, an electric rammer, an electric compactor, an electric pump, an electric pile driver, an electric concrete saw, an electric screed, and an electric cut-off saw.

Examples of the first through third sensors include, but are not limited to, a hall effect sensor, a proximity sensor, a microswitch, and a limit switch.

In one embodiment, Features 1 through 42 may be combined in any combination.

In one embodiment, any of Features 1 through 42 may be removed.

### 2. Specific Example Embodiments

Hereinafter, specific example embodiments will be explained.

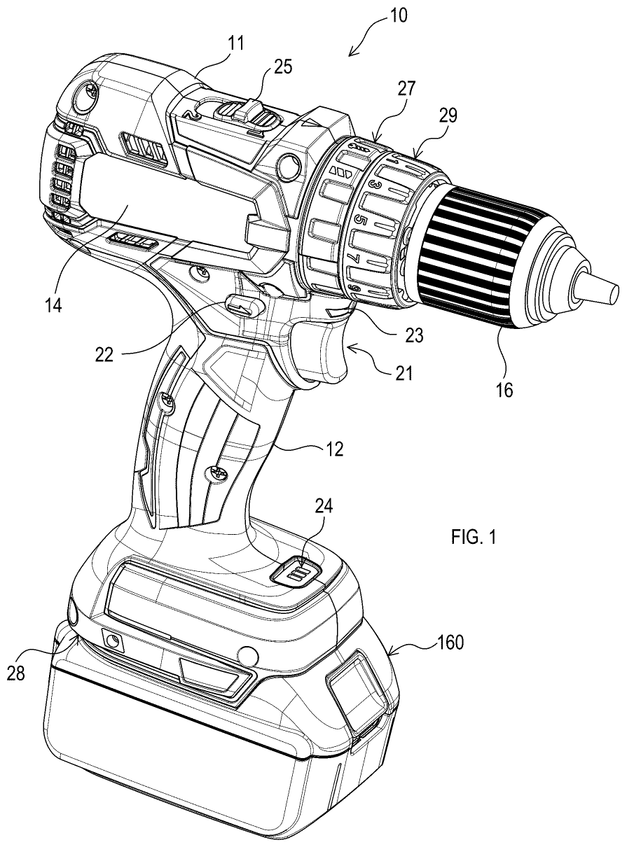

These example embodiments provide an electric work machine 10 in the form of a driver drill as shown in FIG. 1. The driver drill is a type of electric drill or electric screwdriver. However, the electric work machine 10 configured as such is merely an example, and the present disclosure may be applied to electric work machines in any forms.

### 2-1. First Embodiment

### 2-1-1. Mechanical Configuration of Electric Work Machine

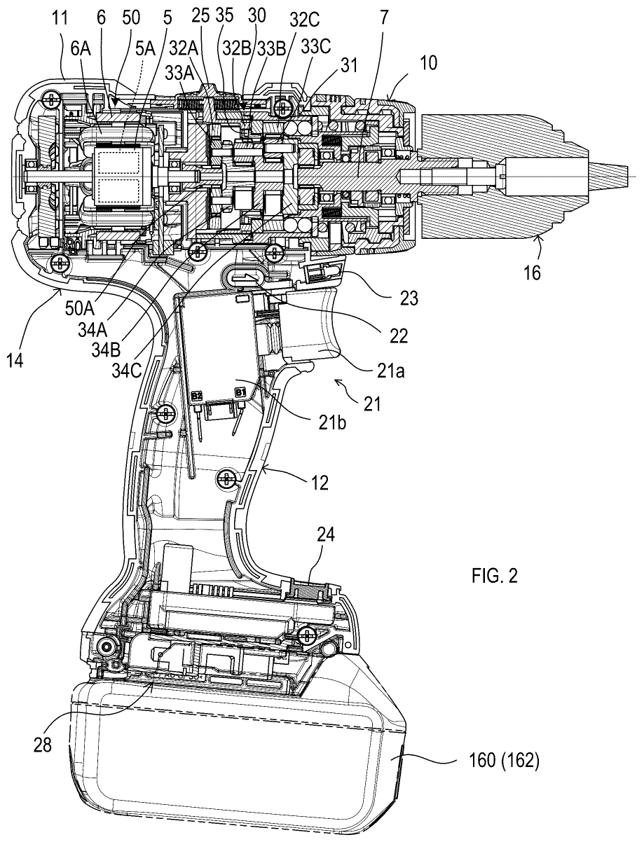

As illustrated in FIGS. 1 and 2, the electric work machine 10 includes a housing 11. The housing 11 houses various components therein. The housing 11 includes a motor container 14. The motor container 14 is provided in a rear part of the housing 11 (on the left in the figures).

The motor container 14 stores a motor 50. The motor 50 is, but not limited to, a three-phase brushless DC motor. The housing 11 stores a gear case 31 in front of the motor container 14. The gear case 31 stores a reduction drive 30. The reduction drive 30 includes an output shaft 7. Details of the reduction drive 30 will be described below.

The electric work machine 10 includes a chuck portion 16. The chuck portion 16 is arranged to protrude from a leading end of the housing 11 (on the right in the figures). The chuck portion 16 is configured to attach a not-shown tool bit to the output shaft 7.

The electric work machine 10 includes a torque selector 29. The torque selector 29 is arranged behind the chuck portion 16. The torque selector 29 includes a component that (i) has an annular shape and (ii) is configured to be rotated by a user of the electric work machine 10 to set a magnitude of a torque (i.e., a tightening force) in a later-described clutch mode.

The electric work machine 10 includes an operating mode selector 27. The operating mode selector 27 is arranged behind the torque selector 29. The operating mode selector 27 includes a component that (i) has an annular shape and (ii) is configured to be rotated by the user to select operating modes of the electric work machine 10. In the first embodiment, the operating modes include, but are not limited to, a drill mode and the clutch mode.

The drill mode is an operating mode for the electric work machine 10 to drill a hole in a workpiece. The clutch mode is an operating mode for the electric work machine 10 to fasten a screw. In the clutch mode, a clutch is disengaged in response to an output torque reaching the magnitude selected through the torque selector 29 to cause the electric work machine 10 not to output the output torque having a magnitude more than or equal to the selected magnitude.

The electric work machine 10 includes a grip 12 configured to be held by the user's hand. The grip 12 downwardly protrudes from the housing 11. The grip 12 includes a trigger 21. The trigger 21 includes a trigger switch 21a configured to be pulled by the user's finger. In addition, the trigger 21 includes a speed setter 21b including a variable resistor.

The electric work machine 10 includes a rotational direction selector switch 22. The rotational direction selector switch 22 is provided above the trigger 21 and at the lower end of the housing 11. The rotational direction selector switch 22 is a manual switch for the user to switch a rotation direction of the motor 50 in a forward direction or a reverse direction. The operating modes of the electric work machine 10 may include a forward rotation mode and a reverse rotation mode. In the forward rotation mode, the motor 50 rotates in a preset forward direction. In the reverse rotation mode, the motor 50 rotates in the direction opposite to the forward direction.

The electric work machine 10 includes a lighting device 23. The lighting device 23 is provided above the trigger 21 and at the front lower end of the housing 11. The lighting device 23 includes one or more light emitting diodes (LEDs). In response to the user pulling the trigger switch 21a, the lighting device 23 emits light ahead of the electric work machine 10.

The electric work machine 10 includes a connector 28 provided on the under surface of the bottom of the grip 12. The connector 28 is configured such that a battery pack 160 can be connected to or detached from the connector 28 by sliding the battery pack 160 onto or off of the connector 28.

The battery pack 160 includes a battery 162 configured to output a specified voltage. The battery 162 is a rechargeable battery. In the first embodiment, the battery 162 is, but not limited to, a lithium-ion battery.

On the top surface of the bottom part of the grip 12, a remaining charge indicator 24 is arranged. The remaining charge indicator 24 (i) includes one or more LEDs and (ii) is configured to indicate a remaining charge of the battery 162.

### 2-1-1-1. Details of Reduction Drive

As illustrated in FIG. 2, the reduction drive (or a reducer) 30 includes first through third internal gears 32A through 32C, first planetary gears 33A, second planetary gears 33B, and third planetary gears 33C. The first through third internal gears 32A through 32C are fixed to an inner peripheral surface of the gear case 31. The first planetary gears 33A revolve in the first internal gear 32A. The second planetary gears 33B revolve in the second internal gear 32B. The third planetary gears 33C revolve in the third internal gear 32C.

The first through third internal gears 32A through 32C are arranged in this order along a rotating shaft of the motor 50 from the motor 50 to the leading end of the housing 11. Similarly, the first planetary gears 33A, the second planetary gears 33B, the third planetary gears 33C are arranged in this order along the rotating shaft of the motor 50 from the motor 50 to the leading end of the housing 11. Each of the first planetary gears 33A, the second planetary gears 33B, and the third planetary gears 33C is arranged around the rotating shaft of the motor 50 at specified angular intervals.

The reduction drive 30 includes first through third carriers 34A through 34C. The first through third carriers 34A through 34C are arranged in this order along the rotating shaft of the motor 50 and rotatable about the rotating shaft of the motor 50. The first carrier 34A (i) is arranged between the first planetary gears 33A and the second planetary gears 33B, (ii) rotatably supports the first planetary gears 33A, and (iii) is fitted to the second planetary gears 33B. The second carrier 34B (i) is arranged between the second planetary gears 33B and the third planetary gears 33C, (ii) rotatably supports the second planetary gears 33B, and (iii) is fitted to the third planetary gears 33C. The third carrier 34C (i) is arranged on the leading end side of the third planetary gears 33C, and (ii) rotatably supports the third planetary gears 33C.

The first planetary gears 33A are fitted to a pinion gear 50A fixed to the rotating shaft of the motor 50. To the third carrier 34C, the output shaft 7 is fixed.

The reduction drive 30 configured as such reduces the rotational speed of the motor 50 in three stages through the first planetary gears 33A, the second planetary gears 33B, the third planetary gears 33C, and the first through third carriers 34A through 34C to transmit the drive torque of the motor 50 to the output shaft 7.

In addition, the reduction drive 30 includes a sliding ring 35. The sliding ring 35 is movable in the gear case 31 along the rotating shaft of the motor 50. The second internal gear 32B is fixed to the sliding ring 35.

The sliding ring 35 is physically connected to an operable component 25. The operable component 25 is provided on the top surface of the housing 11. In response to the user moving the operable component 25 forward or backward, the sliding ring 35 moves forward or backward along the rotating shaft of the motor 50.

In response to the user moving the sliding ring 35 from a front end position to a rear end position through the operable component 25, the second planetary gears 33B are connected to the first carrier 34A by the second internal gear 32B. This allows the first carrier 34A to rotate together with the second carrier 34B. As a result, the reduction drive 30 reduces the rotational speed of the motor 50 in two stages through the first planetary gears 33A, the third planetary gears 33C, the first carrier 34A, and the third carrier 34C to transmit the drive torque of the motor 50 to the output shaft 7.

Thus, in response to the operable component 25 being moved backward, the rotational speed of the motor 50 is reduced by a first reduction ratio (i.e., in two stages) so that the output shaft 7 rotates at a high-speed. In response to the operable component 25 being moved forward, the rotational speed of the motor 50 is reduced by a second reduction ratio (i.e., in three stages) so that the output shaft 7 rotates at a low-speed. The second reduction ratio is greater than the first reduction ratio.

Hereinafter, the operating modes set according to the position of the operable component 25 is referred to as “speed modes”. One of the speed modes is referred to as a “high-speed gear mode”, in which the first reduction ratio is selected. Another one of the speed modes is referred to as a “low-speed gear mode”, in which the second reduction ratio is selected.

The switching of reduction ratios is performed by the user through the operable component 25 as appropriate. In a low-speed rotation, in which the rotational speed of the motor 50 is reduced in three stages, the output torque increases compared to a high-speed rotation, in which the rotational speed of the motor 50 is reduced in two stages.

### 2-1-2. Electrical Configuration of Electric Work Machine

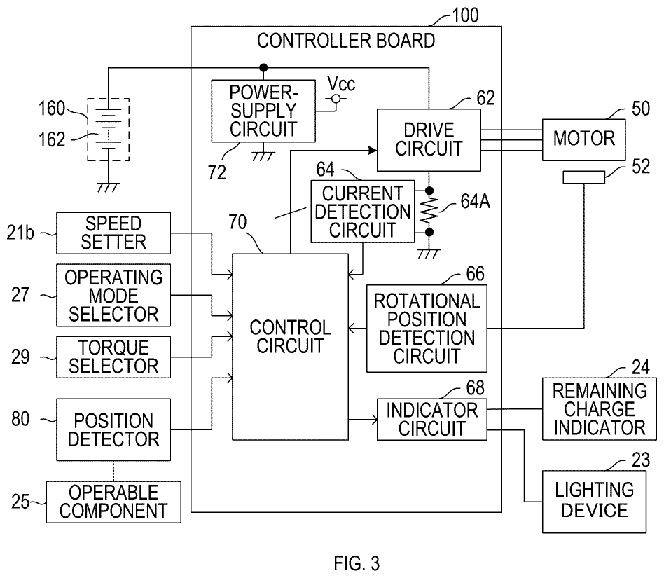

As shown in FIG. 3, the electric work machine 10 includes a rotational position sensor 52. The rotational position sensor 52 includes three Hall effect sensors, which are not shown. The Hall effect sensors are arranged on the stator of the motor 50 so as to respectively correspond to three phase windings of the motor 50. Each time the rotor of the motor 50 rotates by a predetermined angle, the Hall effect sensors output rotation detection signals to a rotational position detection circuit 66. The rotational position detection circuit 66 detects the rotational position of the motor 50 (more specifically, the rotor) based on the rotation detection signals output from the rotational position sensor 52. The rotational position detection circuit 66 is mounted on a controller board 100.

The controller board 100 is arranged in a hollow space between the remaining charge indicator 24 and the connector 28 at the bottom part of the grip 12. On the controller board 100, in addition to the rotational position detection circuit 66, a drive circuit 62, a current detection circuit 64, an indicator circuit 68, a control circuit 70, and a power-supply circuit 72 are mounted.

The drive circuit 62 is, but not limited to, a three-phase full-bridge circuit including three high-side switches and three low-side switches, which are not shown. The drive circuit 62 is coupled to the battery pack 160 and the motor 50. The drive circuit 62 is configured (i) to receive electric power from the battery 162 and (ii) to deliver a drive current to each phase winding of the motor 50. Each of the high-side switches and the low-side switches of the drive circuit 62 is turned ON or OFF in accordance with control signals output from the control circuit 70, which will be described later. Examples of the control signals include, but are not limited to, pulse width modulated (PWM) signals.

The current detection circuit 64 is configured to detect a magnitude of the drive current flowing through the motor 50 via the drive circuit 62. The current detection circuit 64 includes a shunt resistor 64A provided on a current path from the drive circuit 62 to the ground of the controller board 100. The current detection circuit 64 detects the magnitude of the drive current based on a voltage across the shunt resistor 64A and a resistance value of the shunt resistor 64A.

The control circuit 70 is, but not limited to, a microcontroller (or a microcomputer, or a microprocessor) including a CPU, a ROM, a RAM, an analog-to-digital converter, a digital-to-analog converter, input ports, and output ports, which are not shown. In another embodiment, the control circuit 70 may include an additional microcontroller. In yet another embodiment, the control circuit 70 may include a graphics processing unit (GPU), a neural processing unit (NPU), an artificial intelligence (AI) processor, and/or an AI chip, in addition to or in place of the microcontroller. In yet another embodiment, the control circuit 70 may include a logic circuit (or a logic gate, or a wired logic connection) including two or more electronic components, in addition to or in place of the microcontroller. In yet another embodiment, the control circuit 70 may include an application-specific integrated circuit (ASIC) and/or an application-specific standard product (ASSP), in addition to or in place of the microcontroller. In yet another embodiment, the control circuit 70 may include a programmable logic device (PLD) on which a reconfigurable logic circuit can be implemented, in addition to or in place of the microcontroller. Examples of the PLD include, but are not limited to, a field-programmable gate array (FPGA).

The control circuit 70 receives signals from the current detection circuit 64 and the rotational position detection circuit 66. In addition, the control circuit 70 is coupled to the speed setter 21b of the trigger 21, the operating mode selector 27, the torque selector 29, and a later-described position detector 80.

The control circuit 70 (i) sets a desired rotation speed of the motor 50 based on the signals received from these components and (ii) outputs the control signals to the drive circuit 62 such that an actual rotational speed of the motor 50 maintains the desired rotational speed.

In other words, the control circuit 70 drives the motor 50 by turning on and off the high-side switches and the low-side switches of the drive circuit 62. In addition, the control circuit 70 controls timings of turning on and off the high-side switches and the low-side switches in response to the rotational position of the motor 50 detected by the rotational position detection circuit 66.

Consequently, the drive circuit 62 is controlled such that the magnitude of the drive current detected by the current detection circuit 64 corresponds to the desired rotational speed, resulting in the motor 50 being driven at the desired rotational speed. In addition, the control circuit 70 indicates the remaining charge of the battery 162 on the remaining charge indicator 24 and turns on the lighting device 23, via the indicator circuit 68.

The power-supply circuit 72 generates, based on the electric power received from the battery pack 160, a fixed DC voltage (e.g., 5 volts) as a power-supply voltage Vcc to operate the control circuit 70. The power-supply circuit 72 is, but not limited to, a voltage regulator. The power-supply voltage Vcc is also supplied to (i) various circuits on the controller board 100, including the control circuit 70, and to (ii) peripheral circuits including the speed setter 21b, the operating mode selector 27, the torque selector 29, and the position detector 80.

### 2-1-3. Configuration and Operation of Position Detector

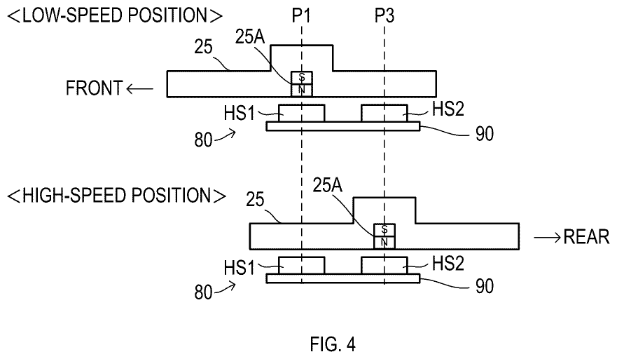

As shown in FIG. 4, the position detector 80 includes a sensor board 90. The sensor board 90 includes a first sensor HS1 and a second sensor HS2 mounted thereon. The sensor board 90 is fixed in the housing 11 such that the first sensor HS1 and the second sensor HS2 face a bottom surface of the operable component 25. In the first embodiment, the first sensor HS1 and the second sensor HS2 are, but not limited to, Hall effect sensors.

On the bottom surface of the operable component 25, a permanent magnet 25A is provided at a center position in the moving direction of the operable component 25. In the first embodiment, the permanent magnet 25A is oriented such that (i) its south-pole faces toward the upper surface of the operable component 25 and (ii) its north-pole faces toward the bottom surface of the operable component 25. In another embodiment, the permanent magnet 25A is oriented such that (i) its north-pole faces toward the upper surface of the operable component 25 and (ii) its south-pole faces toward the bottom surface of the operable component 25.

The first sensor HS1 is arranged on the sensor board 90 to face the permanent magnet 25A when the operable component 25 is positioned at a low-speed position P1, which is the frontmost physical position. The second sensor HS2 is arranged on the sensor board 90 to face the permanent magnet 25A when the operable component 25 is positioned at a high-speed position P3, which is the rearmost physical position.

### 2-1-4. Circuit Configuration on Sensor Board

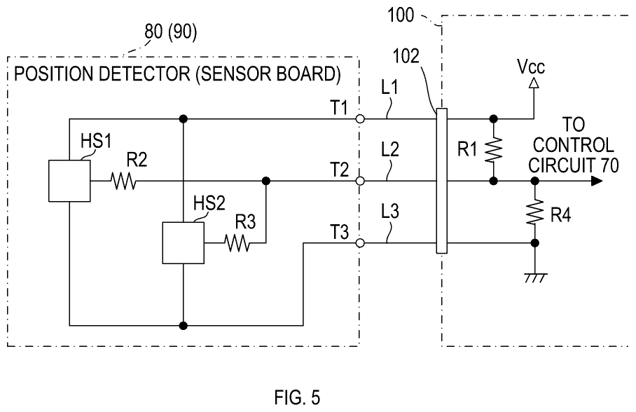

As illustrated in FIG. 5, the sensor board 90 is coupled to the controller board 100 through a power-supply line L1, a signal line L2, a ground line L3, and a connector 102.

The power-supply line L1 delivers the power-supply voltage Vcc from the controller board 100 to a power-supply terminal T1 of the sensor board 90. The signal line L2 delivers a detection signal from an output terminal T2 of the sensor board 90 to the control circuit 70 on the controller board 100. The ground line L3 couples a ground terminal T3 of the sensor board 90 to the ground of the controller board 100 to equalize the reference potential of the sensor board 90 with that of the controller board 100.

The first sensor HS1 and the second sensor HS2 receive the power-supply voltage Vcc through the power-supply terminal T1 and the ground terminal T3 for operation.

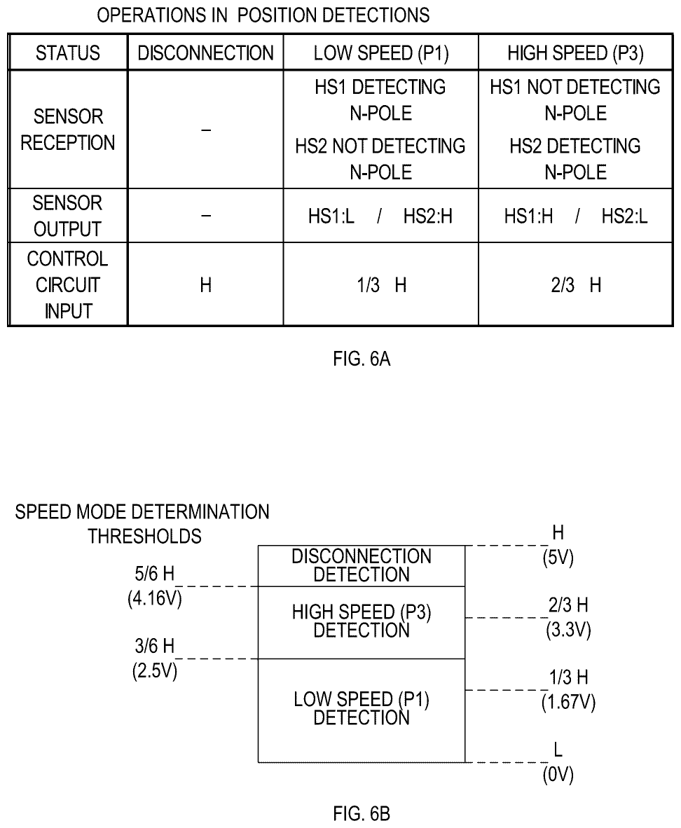

As illustrated in FIG. 6A, when the operable component 25 is positioned at the low-speed position P1, the first sensor HS1 enters its ON state upon detection of the north-pole of the permanent magnet 25A, and its output terminal is set to a low level (L). The low level is comparable to the reference potential. When the operable component 25 is positioned at the high-speed position P3, the second sensor HS2 enters its ON state upon detection of the north-pole of the permanent magnet 25A, and its output terminal is set to the low level.

When the operable component 25 is displaced from the low-speed position P1, the first sensor HS1 does not detect the north-pole of the permanent magnet 25A. Thus, the first sensor HS1 enters its OFF state, and its output terminal is set to a high level (H). The high level is comparable to the power-supply voltage Vcc. When the operable component 25 is displaced from the high-speed position P3, the second sensor HS2 does not detect the north-pole of the permanent magnet 25A. Thus, the second sensor HS2 enters its OFF state, and its output terminal is set to the high level.

As illustrated in FIG. 5, the signal line L2 between the sensor board 90 and the controller board 100 is (i) pulled up to the power-supply voltage Vcc through a pull-up resistor R1, and (ii) pulled down to the ground (i.e., the reference potential) of the controller board 100 through a pull-down resistor R4, on the controller board 100.

On the sensor board 90, the output terminal of the first sensor HS1 is coupled to one end of a first resistor R2. The output terminal of the second sensor HS2 is coupled to one end of a second resistor R3. The other end of the first resistor R2 and the other end of the second resistor R3 are coupled to a shared coupling point, the shared coupling point being coupled to the output terminal T2 of the sensor board 90 through an output path for the detection signal.

In the first embodiment, the resistance value of the first resistor R2, the resistance value of the second resistor R3, and the resistance value of the pull-up resistor R1 are set in the ratio of approximately 1:4:2. Specifically, the resistance value of the pull-up resistor R1 is, but not limited to, 10 kilo-ohms. The resistance value of the first resistor R2 is, but not limited to, 5.1 kilo-ohms. The resistance value of the second resistor R3 is, but not limited to, 20 kilo-ohms.

The pull-down resistor R4 has a resistance value at least ten times greater than that of each of the pull-up resistor R1, the first resistor R2, and the second resistor R3. Specifically, the resistance value of the pull-down resistor R4 is, but not limited to, 1 mega-ohms.

With the above described resistance values, as illustrated in FIG. 6B, when the operable component 25 is positioned at the low-speed position P1, the detection signal received at the controller board 100 (more specifically, the control circuit 70) through the signal line L2 has a voltage level equal to one-third of the power-supply voltage Vcc (⅓H: 1.67 volts).

When the operable component 25 is positioned at the high-speed position P3, the detection signal received at the controller board 100 through the signal line L2 has a voltage level equal to two-thirds of the power-supply voltage Vcc (⅔H: 3.3 volts).

In response to the power-supply line L1, the signal line L2, and/or the ground line L3 being disconnected, the detection signal received at the controller board 100 has a voltage level comparable to the power-supply voltage Vcc (i.e., the high level (H: 5 volts)).

Therefore, the control circuit 70 can detect, based on the voltage level of the detection signal received from the position detector 80 through the signal line L2, (i) that the operable component 25 is positioned at the low-speed position P1 or the high-speed position P3, and (ii) that the power-supply line L1, the signal line L2, and/or the ground line L3 is disconnected.

### 2-1-5. Processes Executed in Control Circuit

Processes executed in the control circuit 70 will be described in detail.

### 2-1-5-1. Control Process

The control circuit 70 repeatedly executes the control process during the operation of the control circuit 70.

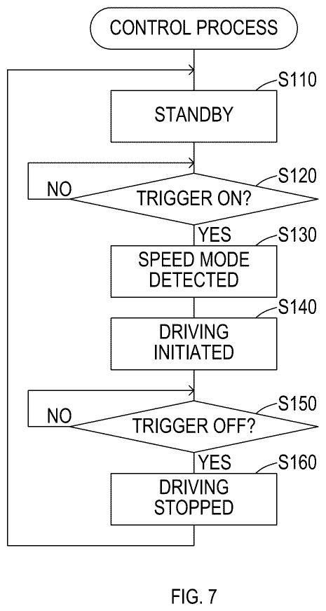

As shown in FIG. 7, upon initiation of the control process, the control circuit 70 enters its standby state, in S110, waiting for proceeding the control process. In subsequent S120, the control circuit 70 in the standby state determines whether the trigger 21 (specifically, the speed setter 21b) is in its ON state.

If the trigger 21 is in its OFF state (S120: NO), the control circuit 70 executes the process at S120 again. If the trigger 21 is in its ON state (S120: YES), the control circuit 70 proceeds to S130. In S130, the control circuit 70 detects the speed mode selected by the user based on the voltage level of the detection signal received from the position detector 80.

In the first embodiment, either the high-speed gear mode or the low-speed gear mode is selected in response to the position of the operable component 25. Accordingly, in S130, the control circuit 70 determines which of the high-speed gear mode or the low-speed gear mode the selected speed mode is. In addition, the control circuit 70 determines, based on the voltage level of the detection signal received, whether the power-supply line L1, the signal line L2, and/or the ground line L3 is disconnected.

In subsequent S140, the control circuit 70 sets the control characteristics for the motor 50 based on at least (i) the setting of the speed mode in S130, (ii) the mode setting selected by the operating mode selector 27, and (iii) the torque setting selected by the torque selector 29. The control circuit 70 then (i) sets the desired rotational speed of the motor 50 based on the control characteristics for the motor 50 and a command signal from the speed setter 21b, and (ii) drives the motor 50 so as to maintain the actual rotational speed of the motor 50 at the desired rotational speed.

In subsequent S150, the control circuit 70 determines whether the trigger 21 (specifically, the speed setter 21b) is in its OFF state. If the trigger 21 is in its ON state (S150: NO), the control circuit 70 executes the process of S150 again. If the trigger 21 is in its OFF state (S150: YES), the control circuit 70 proceeds to S160 to stop the driving of the motor 50. Thereafter, the control circuit 70 returns to S110.

### 2-1-5-2. First Speed Mode Detection Process

In the above S130, the control circuit 70 executes a first speed mode detection process.

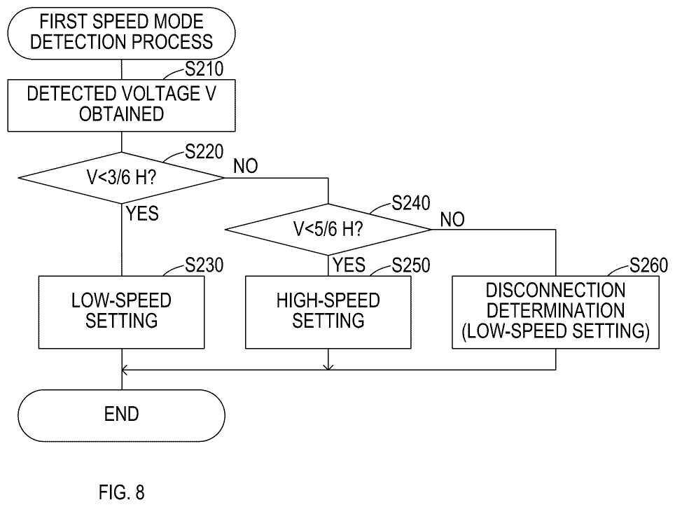

As shown in FIG. 8, in the first speed mode detection process, the control circuit 70 firstly obtains the voltage level of the detection signal received from the position detector 80 (hereinafter, referred to as “detected voltage V”).

In subsequent S220, the control circuit 70 determines whether the detected voltage V obtained is less than a first threshold (which is 3/6H or 2.5 volts) shown in FIG. 6B. If the detected voltage V is less than the first threshold (S220: YES), the operable component 25 is positioned at the low-speed position P1. Accordingly, the control circuit 70 proceeds to S230 to shift the speed mode to the low-speed gear mode (low-speed), and then terminates the first speed mode detection process.

If the detected voltage V is greater than or equal to the first threshold (S220: NO), the control circuit 70 proceeds to S240 to determine whether the detected voltage V is less than a second threshold (which is ⅚H or 4.16 volts). If the detected voltage V is less than the second threshold (S240: YES), the operable component 25 is positioned at the high-speed position P3. Accordingly, the control circuit 70 proceeds to S250 to shift the speed mode to the high-speed gear mode (high-speed). Then, the control circuit 70 terminates the first speed mode detection process.

If the detected voltage V is greater than or equal to the second threshold (S240: NO), the control circuit 70 proceeds to S260. In S260, the control circuit 70 determines that the power-supply line L1, the signal line L2, and/or the ground line L3 is disconnected. Thereafter, the control circuit 70 terminates the first speed mode detection process.

In addition, the control circuit 70 shifts the speed mode to the low-speed gear mode (low-speed) in S260 because the control circuit 70 cannot appropriately obtain the detected voltage V from the position detector 80 due to a disconnection of the power-supply line L1, the signal line L2, and/or the ground line L3. This is to inhibit the motor 50 from being driven in the high-speed gear mode as a result of the control circuit 70 incorrectly determining, due to external noise, that the selected reduction ratio of the reduction drive 30 is the first reduction ratio although the actual selected reduction ratio is the second reduction ratio.

Specifically, in a case where external noise causes an incorrect determination of the reduction ratio of the reduction drive 30 to thereby cause the motor 50 to be driven in the high-speed gear mode, an abrupt rise in rotational speed of the output shaft 7 may occur. In order to avoid such an event from occurring, the control circuit 70 shifts the speed mode to the low-speed gear mode (low-speed) in S260. Consequently, in the first embodiment, it is possible to inhibit the deterioration of safety caused by erroneous control of the motor 50 due to a disconnection of the power-supply line L1, the signal line L2, and/or the ground line L3.

### 2-1-6. Effects in First Embodiment

As described above, the electric work machine 10 of the first embodiment includes the position detector 80 to detect the position of the operable component 25 for switching the reduction ratios of the reduction drive 30. The position detector 80 is provided with the first sensor HS1 and the second sensor HS2. The position detector 80 outputs the detection signal to the controller board 100 through the signal line L2 shared by the first sensor HS1 and the second sensor HS2.

The voltage level of the detection signal varies in response to the position of the operable component 25. Therefore, the control circuit 70 can detect, based on the voltage level of the detection signal, the position of the operable component 25, and thus detect the speed mode of the reduction drive 30.

The voltage level of the detection signal is set by dividing the power-supply voltage Vcc using the pull-up resistor R1, the first resistor R2, the second resistor R3, and the pull-down resistor R4. As a result, the voltage levels respectively corresponding to the low-speed position P1 and the high-speed position P3 are different from the high level and the low level.

In the first embodiment, the resistance value of the pull-down resistor R4 is at least ten times greater than the respective resistance values of the remaining resistors. Accordingly, when the power-supply line L1, the signal line L2, and/or the ground line L3 is disconnected, the voltage level of the detection signal received at the controller board 100 is set to the high level.

Therefore, the control circuit 70 can correctly detect, based on the voltage level of the detection signal, not only the position of the operable component 25 but also a disconnection of the power-supply line L1, the signal line L2, and/or the ground line L3.

Since the resistance values of the first resistor R2, the second resistor R3, and the pull-up resistor R1 are in the ratio of 1:4:2, the power-supply voltage Vcc can be divided into equal voltage intervals. Thus, the control circuit 70 can more accurately detect the position of the operable component 25 by setting the thresholds for determining the speed mode to define the equal voltage intervals.

Since the pull-up resistor R1 and the pull-down resistor R4 are provided on the controller board 100, the number of components of the position detector 80 can be reduced, helping reduce the size of the position detector 80.

### 2-1-7. Correspondence Between Terms

In the first embodiment, the controller board 100 corresponds to an example of the controller in Overview of Embodiments.

### 2-2. Second Embodiment

In the aforementioned first embodiment, the reduction drive 30 is configured to switch between two reduction ratios. However, the reduction drive 30 may be configured to switch between three or more reduction ratios.

Accordingly, in this second embodiment, descriptions will be given of the configuration of the position detector 80 and a second speed mode detection process executed in the control circuit 70 when the reduction drive 30 is configured to switch between three reduction ratios.

Since the configuration of the reduction drive 30 capable of switching between three reduction ratios is publicly known, such a configuration of the reduction drive 30 will not be described further.

### 2-2-1. Configuration and Operation of Position Detector

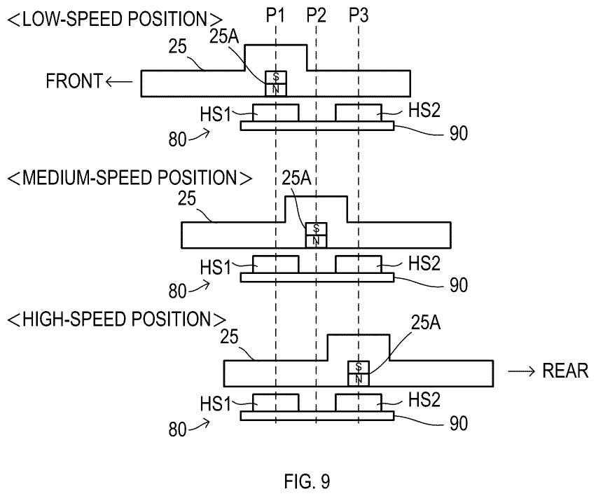

As illustrated in FIG. 9, in the second embodiment, the operable component 25 is configured to be moved to one of (i) the low-speed position P1, (ii) the high-speed position P3, and (iii) a medium-speed position P2, which is situated between the low-speed position P1 and the high-speed position P3.

Similarly to the one in the first embodiment, the permanent magnet 25A is provided on the bottom surface of the operable component 25 at the center position in the moving direction of the operable component 25. Moreover, the position detector 80 also includes, as in the first embodiment, the sensor board 90 on which the first sensor HS1 and the second sensor HS2 are mounted. The sensor board 90 is fixed in the housing 11 to face the bottom surface of the operable component 25.

On the sensor board 90, the first sensor HS1 is positioned to face the permanent magnet 25A when the operable component 25 is positioned at the low-speed position P1, which is the frontmost physical position. The second sensor HS2 is positioned to face the permanent magnet 25A when the operable component 25 is positioned at the high-speed position P3, which is the rearmost physical position.

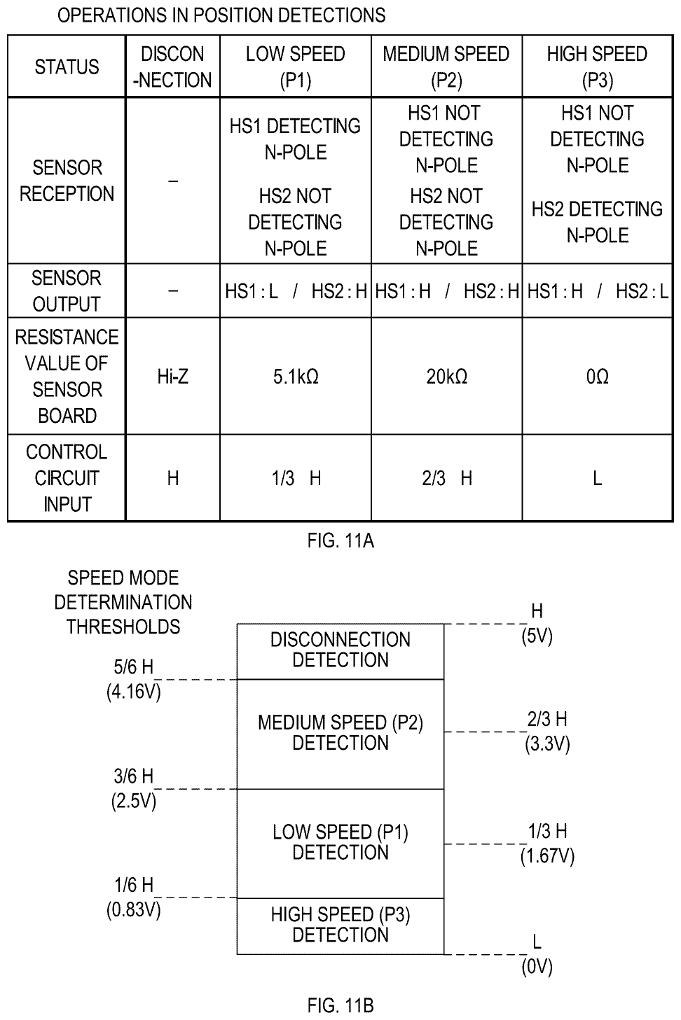

With this configuration, as illustrated in FIG. 11A, when the operable component 25 is positioned at the low-speed position P1, the first sensor HS1 enters its ON state, and the second sensor HS2 enters its OFF state. In this case, the output terminal of the first sensor HS1 is set to the low level, and the output terminal of the second sensor HS2 is set to the high level.

When the operable component 25 is positioned at the high-speed position P3, the first sensor HS1 enters its OFF state, and the second sensor HS2 enters its ON state. In this case, the output terminal of the first sensor HS1 is set to the high level, and the output terminal of the second sensor HS2 is set to the low level.

When the operable component 25 is positioned at the medium-speed position P2, both the first sensor HS1 and the second sensor HS2 are in their respective OFF states. In this case, the respective output terminals of the first sensor HS1 and the second sensor HS2 are set to the high level.

### 2-2-2. Circuit Configurations on Sensor Board and Controller Board

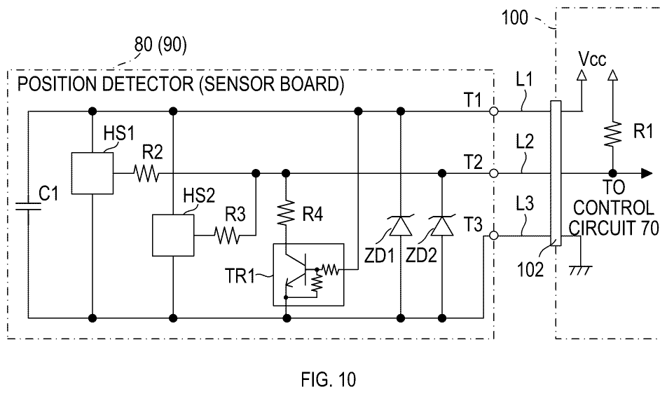

As illustrated in FIG. 10, the sensor board 90 is coupled to the controller board 100 through the power-supply line L1, the signal line L2, the ground line L3, and the connector 102, as in the first embodiment. In this second embodiment, the first resistor R2, the second resistor R3, and the pull-down resistor R4 are mounted on the sensor board 90, and the pull-up resistor R1 is mounted on the controller board 100.

One end of the first resistor R2 and one end of the second resistor R3 are coupled to the output terminals of the first sensor HS1 and the second sensor HS2, respectively, and the other end of the first resistor R2 and the other end of the second resistor R3 are coupled to the shared coupling point. The shared coupling point is coupled to the output terminal T2 of the sensor board 90 through the output path for the detection signal. In other words, such a configuration is similar to the one in the first embodiment.

The pull-down resistor R4 is coupled at one end to the output path extending from the shared coupling point, and also to the output terminal T2. The other end of the pull-down resistor R4 is coupled to a semiconductor switch TR1.

In the second embodiment, the semiconductor switch TR1 is, but not limited to, an NPN bipolar transistor. In another embodiment, the semiconductor switch TR1 may be of a different type, including but not limited to a MOSFET, a JFET, or an IGBT. In yet another embodiment, the semiconductor switch TR1 may be replaced with a mechanical relay.

The other end of the pull-down resistor R4 is coupled to a collector of the semiconductor switch TR1. The semiconductor switch TR1 includes an emitter coupled to the reference potential through the ground terminal T3. The semiconductor switch TR1 also includes a base coupled (i) to the emitter of the semiconductor switch TR1 via a resistor inside the semiconductor switch TR1 and (ii) to the power-supply terminal T1 via an additional resistor inside the semiconductor switch TR1.

In such a circuit configuration, the semiconductor switch TR1 enters its ON state while being supplied with the power-supply voltage Vcc from the controller board 100. Accordingly, the other end of the pull-down resistor R4 is coupled to the reference potential through the semiconductor switch TR1 only while the power supply voltage Vcc is supplied to the semiconductor switch TR1 from the controller board 100.

In addition, the sensor board 90 includes a first Zener diode ZD1, a second Zener diode ZD2, and a capacitor C1 thereon. The first Zener diode ZD1 is coupled at its anode to the ground terminal T3 and at its cathode to the power-supply terminal T1. The second Zener diode ZD2 is coupled at its anode to the ground terminal T3 and at its cathode to the output terminal T2.

The first Zener diode ZD1 and the second Zener diode ZD2 have their respective breakdown voltages set to a fixed voltage (e.g., 7.5 volts) higher than the power-supply voltage Vcc. Thus, the respective voltages at the power-supply terminal T1 and the output terminal T2 are limited to 7.5 volts or lower.

The capacitor C1 is coupled at one end to the power-supply terminal T1 and at the other end to the ground terminal T3. The capacitor C1 together with the first Zener diodes ZD1 and the second Zener diode ZD2 suppress noise superimposed on the power-supply line L1 and the signal line L2. The capacitor C1 has a capacitance of 0.1 microfarads and a rated voltage of 50 volts. However, the capacitance and the rated voltage of the capacitor C1 are not limited to these values.

In the second embodiment, the combination of the capacitor C1, the first Zener diode ZD1, and the second Zener diode ZD2 can suppress noise, thereby reducing noise intrusion into the controller board 100 via the power-supply line L1 and the signal line L2.

In the second embodiment, the resistance value of the pull-up resistor R1 is, but not limited to, 10 kilo-ohms. The resistance value of the first resistor R2 is, but not limited to, 6.8 kilo-ohms. The resistance value of the second resistor R3 is, but not limited to, zero ohms. The resistance value of the pull-down resistor R4 is, but not limited to, 20 kilo-ohms.

As shown in FIG. 11A, these resistance values are selected such that the resistance value of the position detector 80 as viewed from the control circuit 70 is set (i) to 5.1 kilo-ohms in response to the operable component 25 being positioned at the low-speed position P1, (ii) to 20 kilo-ohms in response to the operable component 25 being positioned at the medium-speed position P2, and (iii) to zero ohms in response to the operable component 25 being positioned at the high-speed position P3.

As a result, as shown in FIGS. 11A and 11B, when the operable component 25 is positioned at the low-speed position P1, the detection signal received at the controller board 100 has a voltage level equal to one-third of the power-supply voltage Vcc (⅓H: 1.67 volts). When the operable component 25 is positioned at the medium-speed position P2, the detection signal has a voltage level equal to two-thirds of the power-supply voltage Vcc (⅔H: 3.3 volts). When the operable component 25 is positioned at the high-speed position P3, the detection signal has a voltage level comparable to the reference potential (i.e., the low level).

When the power-supply line L1, the signal line L2, and/or the ground line L3 is disconnected, the resistance value of the position detector 80 as viewed from the controller board 100 is set to a high value (i.e., Hi-Z). Since the pull-up resistor R1 is provided on the controller board 100, the voltage level of the detection signal received at the controller board 100 is set to the high level (H: 5 volts).

Thus, the control circuit 70 can detect, based on the voltage level of the detection signal, (i) that the operable component 25 is positioned at the low-speed position P1, the medium-speed position P2, or the high-speed position P3, and (ii) that the power-supply line L1, the signal line L2 and/or the ground line L3 is disconnected.

### 2-2-3. Second Speed Mode Detection Process

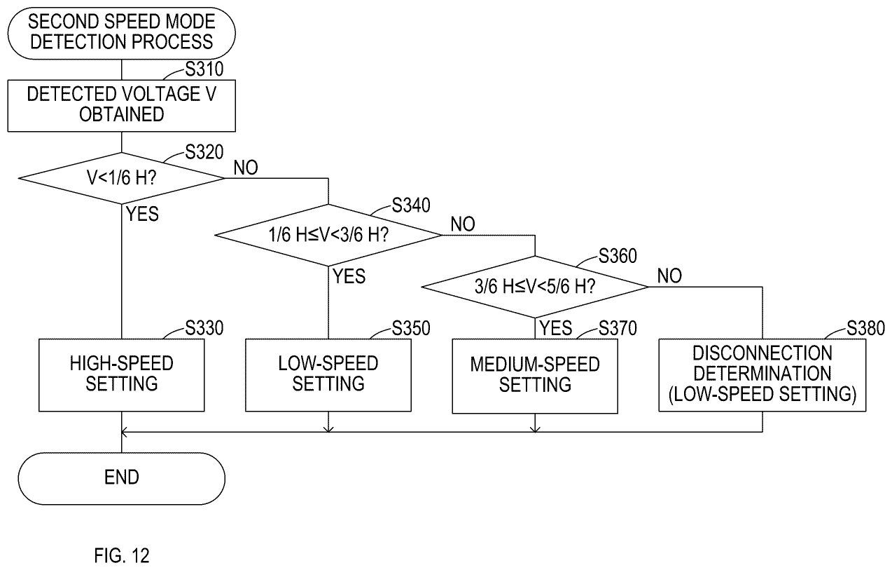

A description will be given of a second speed mode detection process executed in the control circuit 70 with reference to a flowchart shown in FIG. 12. As in the first embodiment, the second speed mode detection process is executed, in place of the first speed mode detection process, in S130 of the control process shown in FIG. 7.

As shown in FIG. 12, in the second speed mode detection process, the control circuit 70 firstly obtains the detected voltage V in S310. In subsequent S320, the control circuit 70 determines whether the detected voltage V obtained is less than a first threshold indicated in FIG. 11B (i.e., ⅙H or 0.83 volts). If the detected voltage V is less than the first threshold (S320: YES), the operable component 25 is positioned at the high-speed position P3. Accordingly, the control circuit 70 proceeds to S330 to shift the speed mode to the high-speed gear mode (high-speed). Then, the control circuit 70 terminates the second speed mode detection process.

If the detected voltage V is greater than or equal to the first threshold (S320: NO), the control circuit 70 proceeds to S340 to determine whether the detected voltage V obtained is less than a second threshold (i.e., 3/6H or 2.5 volts). If the detected voltage V is less than the second threshold (S340: YES), the operable component 25 is positioned at the low-speed position P1. Accordingly, the control circuit 70 proceeds to S350 to shift the speed mode to the low-speed gear mode (low-speed). Then, the control circuit 70 terminates the second speed mode detection process.

If the detected voltage V is greater than or equal to the second threshold (S340: NO), the control circuit 70 proceeds to S360 to determine whether the detected voltage V obtained is less than a third threshold (i.e., ⅚H or 4.16 volts). If the detected voltage V is less than the third threshold (S360: YES), the control circuit 70 proceeds to S370 to shift the speed mode to a medium-speed gear mode (medium-speed). Then, the control circuit 70 terminates the second speed mode detection process.

If the detected voltage V is greater than or equal to the third threshold (S360: NO), the control circuit 70 proceeds to S380. In S380, the control circuit 70 determines that the power-supply line L1, the signal line L2, and/or the ground line L3 is disconnected, and then terminates the second speed mode detection process. In S380, as in the process in S260 in the first speed mode detection process, the control circuit 70 shifts the speed mode to the low-speed gear mode (low-speed).

### 2-2-4. Effects in Second Embodiment

In the second embodiment, the reduction drive 30 is configured to switch between three gear ratios. Accordingly, the position of the operable component 25 is switched between three stages: the low-speed position P1, the medium-speed position P2, and the high-speed position P3. As in the first embodiment, the position detector 80 includes the first sensor HS1 and the second sensor HS2, and detects the position of the operable component 25 by the first sensor HS1 and the second sensor HS2.

The sensor board 90 of the position detector 80 includes the pull-down resistor R4 thereon in addition to the first sensor HS1, the first resistor R2, the second sensor HS2, and the second resistor R3. The pull-down resistor R4 is coupled to the reference potential through the semiconductor switch TR1 in response to the power-supply voltage Vcc being supplied to the position detector 80 from the controller board 100. The controller board 100 includes the pull-up resistor R1 thereon.

Thus, the position detector 80 outputs the detection signal having a voltage level (i.e., ⅓H, ⅔H, or L) that corresponds to the position of the operable component 25. When the power-supply line L1, the signal line L2, and/or the ground line L3 is disconnected, the voltage level of the detection signal received at the controller board 100 is set to the high level (H).

Based on such a voltage level of the detection signal, the control circuit 70 can detect (i) the position of the operable component 25 (in other words, the speed mode) and (ii) a disconnection of the power-supply line L1, the signal line L2, and/or the ground line L3.

In the second embodiment, the respective resistance values of the first resistor R2 and the second resistor R3 are set to 6.8 kilo-ohms and zero ohms. However, the resistance value of the first resistor R2 may be set to zero ohms, and the resistance value of the second resistor R3 may be set to 6.8 kilo-ohms. Such a case also can exhibit the effects similar to those mentioned above. In other words, by setting the resistance value of either the first resistor R2 or the second resistor R3 to zero ohms, the voltage level of the detection signal is set to the low level when the operable component 25 is positioned at the low-speed position P1 or the high-speed position L3, which enables the control circuit 70 to detect the position of the operable component 25 base on three distinct voltage levels different from the high level.

### 2-3. Third Embodiment

In the third embodiment, the reduction drive 30 is configured to switch between three reduction ratios, as in the second embodiment. The sensor board 90 and the controller board 100 include circuit configurations partially modified from those in the first embodiment.

### 2-3-1. Circuit Configurations on Sensor Board and Controller Board

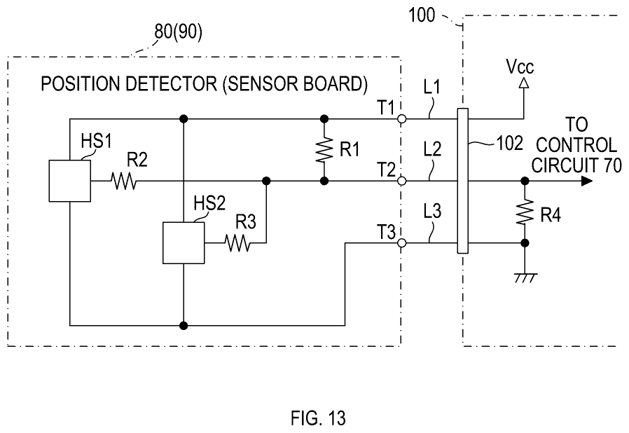

As illustrated in FIG. 13, in the third embodiment, the pull-up resistor R1 is mounted not on the controller board 100 but on the sensor board 90. The resistance values of the pull-up resistor R1, the first resistor R2, the second resistor R3, and the pull-down resistor R4 are the same as those of the respective resistors in the first embodiment.

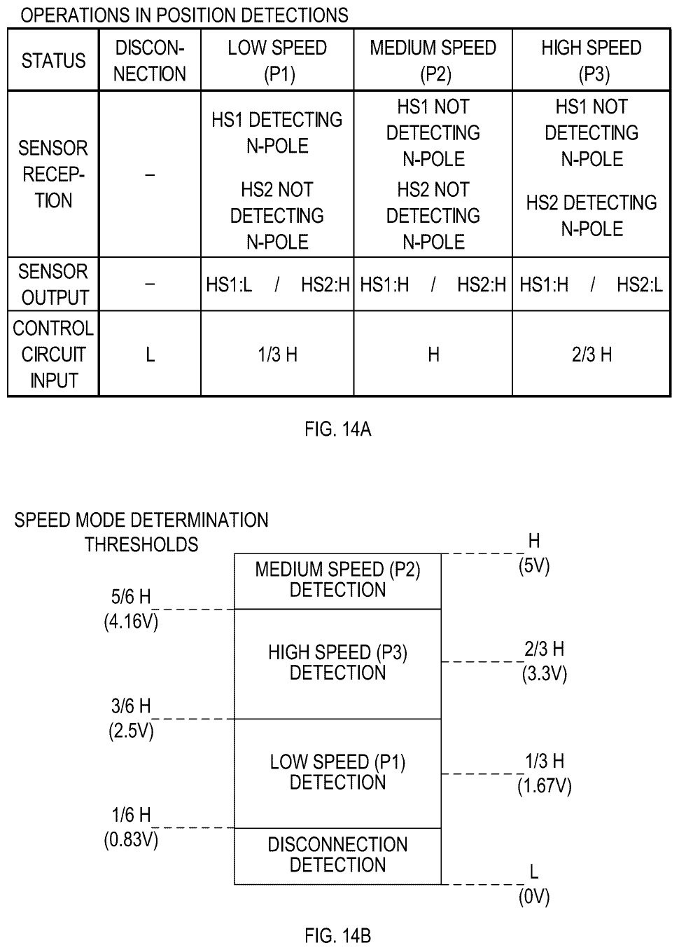

In such circuit configurations, as indicated in FIGS. 14A and 14B, the voltage level of the detection signal received at the controller board 100 is set to the low level when the power-supply line L1, the signal line L2, and/or the ground line L3 is disconnected.

When the operable component 25 is positioned at the low-speed position P1, the detection signal has a voltage level equal to one-third of the power-supply voltage Vcc (i.e., ⅓H: 1.67 volts). When the operable component 25 is positioned at the high-speed position P3, the detection signal has a voltage level equal to two-thirds of the power-supply voltage Vcc (i.e., ⅔H: 3.3 volts). When the operable component 25 is positioned at the medium speed position P2, the voltage level of the detection signal is set to the high level (i.e., H: 5 volts).

Accordingly, the control circuit 70 can determine, based on the thresholds for the speed mode determination set as shown in FIG. 14B, at which of the low-speed position P1, the medium-speed position P2, or the high-speed position P3 the operable component 25 is positioned. In addition, the control circuit 70 can accurately determine whether the power-supply line L1, the signal line L2 and/or the ground line L3 is disconnected.

Therefore, the third embodiment can exhibit the same effects as in the first and second embodiments.

### 2-4. Fourth Embodiment

In the fourth embodiment, the reduction drive 30 is configured to switch between four reduction ratios. Since the configuration of the reduction drive 30 capable of switching between four reduction ratios is publicly known, such a configuration of the reduction drive 30 will not be described further. The configuration of the position detector 80 in the fourth embodiment is modified as follows.

### 2-4-1. Configuration and Operation of Position Detector

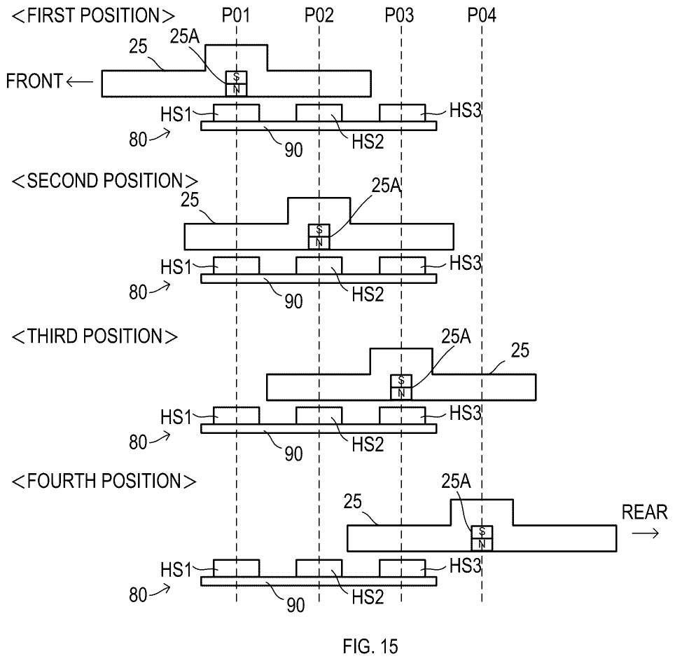

In the fourth embodiment, as illustrated in FIG. 15, the operable component 25 is configured to be moved to any one of a first position P01, a second position P02, a third position P03, and a fourth position P04, from the front toward the rear or vice versa. The sensor board 90 includes a third sensor HS3 thereon in addition to the first sensor HS1 and the second sensor HS2.

The first sensor HS1 is positioned to face the permanent magnet 25A when the operable component 25 is positioned at the first position P01. The second sensor HS2 is positioned to face the permanent magnet 25A when the operable component 25 is positioned at the second position P02. The third sensor HS3 is positioned to face the permanent magnet 25A when the operable component 25 is positioned at the third position P03.

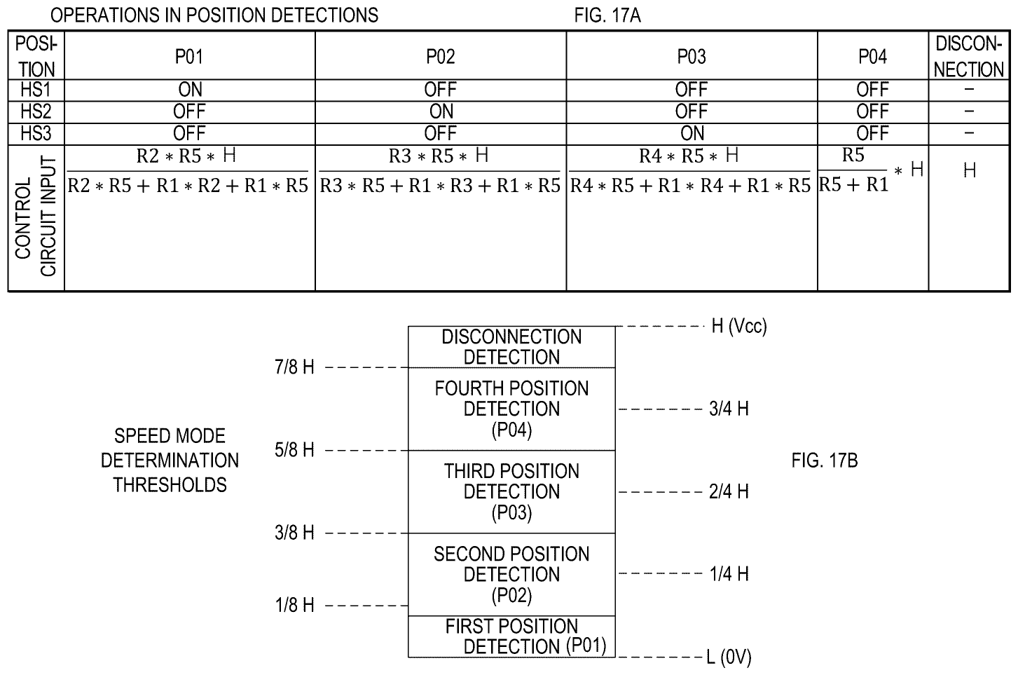

Accordingly, as indicated in FIG. 17A, the first sensor HS1 enters its ON state, and the second and third sensors HS2 and HS3 enter their respective OFF states when the operable component 25 is positioned at the first position P01. The second sensor HS2 enters its ON state, and the first and third sensors HS1 and HS3 enter their respective OFF states when the operable component 25 is positioned at the second position P02. The third sensor HS3 enters its ON state, and the first and second sensors HS1 and HS2 enter their respective OFF states when the operable component 25 is positioned at the third position P01. All the first through third sensors HS1 through HS3 enter their respective OFF states when the operable component 25 is positioned at the fourth position P04.

### 2-4-2. Circuit Configurations on Sensor Board and Controller Board

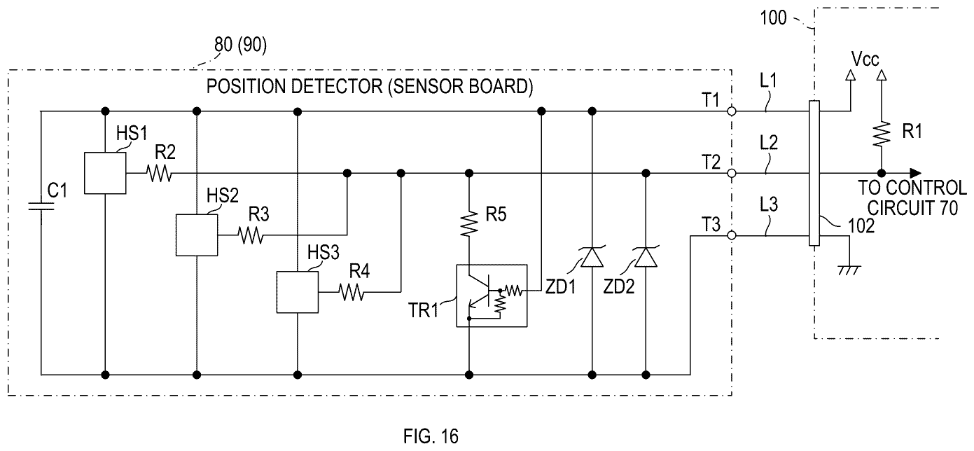

As illustrated in FIG. 16, the sensor board 90 is coupled to the controller board 100 through the power-supply line L1, the signal line L2, the ground line L3, and the connector 102, as in the first through third embodiments.

The circuit configuration of the sensor board 90 is substantially the same as that of the sensor board 90 of the second embodiment. In the fourth embodiment, the third sensor HS3 and a third resistor R4 are added on the sensor board 90, and a reference numeral R5 is assigned to the pull-down resistor instead of the reference numeral R4.

The third sensor HS3 is coupled in parallel with the first sensor HS1 and the second sensor HS2 and receives the power-supply voltage Vcc through the power-supply terminal T1 and the ground terminal T3 for operation. The third resistor R4 is coupled at one end to the output terminal of the third sensor HS3 and at the other end to the output path.

In the position detector 80 of the fourth embodiment configured as described above, as in the first through third embodiments, the voltage level of the detection signal varies depending on the position of the operable component 25. Specifically, as indicated in FIG. 17A, the voltage of the detection signal is obtained by dividing the power-supply voltage Vcc using (i) the pull-up resistor R1 on the controller board 100 and (ii) an equivalent resistor (or a combined resistor) of the resistors R2 though R5 coupled in parallel on the sensor board 90.

In the fourth embodiment, as indicated in FIG. 17B, the voltage level of the detection signal is set to the low level when the operable component 25 is positioned at the first position P01, due to the first resistor R2 having a resistance value of zero ohms.

The respective resistance values of the remaining resistors R1, and R3 through R5 are set such that the voltage level of the detection signal changes by a constant voltage interval in response to the operable component 25 being moved between the adjacent positions, from the second position P02 to the fourth position P04 and vice versa.

Specifically, in the fourth embodiment, the detection signal has a voltage level equal to a quarter of the power-supply voltage Vcc (i.e., ¼H), when the operable component 25 is positioned at the second position P02. The detection signal has a voltage level equal to two-fourths of the power-supply voltage Vcc (i.e., 2/4H), when the operable component 25 is positioned at the third position P03. The detection signal has a voltage level equal to three-fourths of the power-supply voltage Vcc (i.e., ¾H), when the operable component 25 is positioned at the fourth position P04.

In the fourth embodiment, since the pull-up resistor R1 is provided on the controller board 100, when the power-supply line L1, the signal line L2, and/or the ground line L3 is disconnected, the voltage level of the detection signal received at the controller board 100 is set to the high level (H).

Accordingly, the control circuit 70 can determine, using the thresholds for the speed mode determination set as shown in FIG. 17B, at which of the first through fourth positions P01 through P04 the operable component 25 is positioned, based on the voltage level of the detection signal. In addition, the control circuit 70 can accurately determine whether the power-supply line L1, the signal line L2 and/or the ground line L3 is disconnected based on the voltage level of the detection signal.

Therefore, the fourth embodiment can exhibit the same effects as in the first through third embodiments.

In a case where the operable component 25 can be moved to five or more positions, an additional sensor(s) may be added on the sensor board 90 in addition to the first through third sensors HS1 through HS3. With such a configuration, the control circuit 70 can determine at which of the five or more positions the operable component 25 is positioned.

In the fourth embodiment, the third sensor HS3 and the third resistor R4 are added on the sensor board 90 of the second embodiment illustrated in FIG. 10, in order to detect the operable component 25 positioned in any one of the first through fourth positions P01 through P04.

The third sensor HS3 and the third resistor R4 may be added on the sensor board 90 of the third embodiment illustrated in FIG. 13, in place of the sensor board 90 of the second embodiment. Such a configuration also can detect the operable component 25 positioned at any one of the first through fourth positions P01 through P04.

### 2-5. Further Embodiments

The example embodiments of the present disclosure have been described so far; however, the present disclosure can be carried out in variously modified forms without being limited to the above first through fourth embodiments.

The first through third sensors HS1 through HS3 may be of different types, including but not limited to a proximity sensor, a microswitch, or a limit switch. The first through third sensor may be contact sensors or non-contact sensors.

In the second and fourth embodiments, the capacitor C1, the first Zener diode ZD1, and the second Zener diodes ZD2 may be removed from the sensor board 90. In such a case, the position detector 80 may be reduced in size.

Alternatively, in the first and third embodiments, the capacitor C1, the first Zener diode ZD1, and the second Zener diode ZD2 may be added on the sensor board 90.

### 2-6. Supplementary Explanation

Two or more functions achieved by one element of the above-described embodiments may be achieved by two or more elements. One function achieved by one element may be achieved by two or more elements. Two or more functions achieved by two or more elements may be achieved by one element. One function achieved by two or more elements may be achieved by one element. A part of the configurations in the above-described embodiments may be omitted. At least a part of the configurations in any one of the above-described embodiments may be added to or replaced with at least a part of the configurations in another one of the above-described embodiments.

What is claimed is:

1. An electric work machine, comprising:
a motor configured to drive a tool;
an operable component configured to be manually moved by a user of the electric work machine to switch operating modes of the motor;
a controller configured (i) to receive a detection signal, and (ii) to switch the operating modes of the motor in response to a voltage level of the detection signal;
a signal line coupled to the controller;
a position detector (i) coupled to the signal line, and (ii) configured to output the detection signal to the controller through the signal line, the position detector including:
a first resistor (i) having a first resistance value, and (ii) coupled to the signal line;
a second resistor (i) distinct from the first resistor, (ii) having a second resistance value that is different from the first resistance value, and (iii) coupled to the signal line in parallel with the first resistor;
a first sensor including a first output terminal, the first sensor being configured (i) to set the first output terminal to a first voltage level in response to the operable component being positioned at a first position, and (ii) to set the first output terminal to a second voltage level in response to the operable component being displaced from the first position, the first output terminal being coupled to the signal line through the first resistor, the first voltage level being comparable to either (i) a preset reference potential, or (ii) a preset power-supply voltage that is higher than the preset reference potential, the second voltage level being the inverse of the first voltage level;
a second sensor (i) distinct from the first sensor, and (ii) including a second output terminal, the second sensor being configured (i) to set the second output terminal to the first voltage level in response to the operable component being positioned at a second position, and (ii) to set the second output terminal to the second voltage level in response to the operable component being displaced from the second position, the second output terminal being coupled to the signal line through the second resistor, the second position being distinct from the first position;
a pull-up resistor provided in the electric work machine to pull up the signal line to the preset power-supply voltage; and
a pull-down resistor provided in the electric work machine to pull down the signal line to the preset reference potential.

2. The electric work machine according to claim 1,
wherein the pull-up resistor and/or the pull-down resistor is provided in the controller.

3. The electric work machine according to claim 2, wherein:
the pull-up resistor is provided in the controller, and
the pull-down resistor is provided in the position detector.

4. The electric work machine according to claim 3,
wherein either the first resistance value or the second resistance value is zero ohms.

5. The electric work machine according to claim 3,
wherein the pull-down resistor is provided in the position detector to couple to the preset reference potential through a semiconductor switch.

6. The electric work machine according to claim 5, further comprising
a power-supply line configured to supply the preset power-supply voltage from the controller to the first sensor and the second sensor, wherein:
the first sensor and the second sensor are configured to receive the preset power-supply voltage to operate, and
the semiconductor switch is configured to conduct in response the preset power-supply voltage being applied to the first sensor and the second sensor.

7. The electric work machine according to claim 2, wherein:
the pull-up resistor is provided in the position detector, and
the pull-down resistor is provided in the controller.

8. The electric work machine according to claim 7,
wherein the controller is configured to receive the detection signal with the voltage level comparable to the preset power-supply voltage in response to (i) the signal line not being disconnected, and (ii) the operable component being displaced from both the first position and the second position.

9. The electric work machine according to claim 2,
wherein both the pull-up resistor and the pull-down resistor are provided in the controller.

10. The electric work machine according to claim 9,
wherein the controller is configured to receive the detection signal with the voltage level comparable to the preset power-supply voltage in response to the signal line being disconnected.

11. The electric work machine according to claim 7,
wherein each of the first resistance value and the second resistance value is greater than zero ohms.

12. The electric work machine according to claim 9,
wherein each of the first resistance value and the second resistance value is greater than zero ohms.

13. The electric work machine according to claim 7, wherein:
the pull-up resistor is provided to directly couple to the preset power-supply voltage, and
the pull-down resistor is provided to directly couple to the preset reference potential.

14. The electric work machine according to claim 9, wherein:
the pull-up resistor is provided to directly couple to the preset power-supply voltage, and
the pull-down resistor is provided to directly couple to the preset reference potential.

15. The electric work machine according to claim 7, wherein:
the pull-up resistor has a third resistance value, and
the pull-down resistor has a fourth resistance value at least ten times greater than each of the first through third resistance values.

16. The electric work machine according to claim 9, wherein:
the pull-up resistor has a third resistance value, and
the pull-down resistor has a fourth resistance value at least ten times greater than each of the first through third resistance values.

17. The electric work machine according to claim 15,
wherein the first resistance value, the second resistance value, and the third resistance value are in the ratio of 1:4:2.

18. The electric work machine according to claim 16,
wherein the first resistance value, the second resistance value, and the third resistance value are in the ratio of 1:4:2.

19. The electric work machine according to claim 1,
wherein the position detector further includes:
a third resistor (i) distinct from both the first resistor and the second resistor, (ii) having a fifth resistance value that is different from both the first resistance value and the second resistance value, and (iii) coupled to the signal line in parallel with the first resistor and the second resistor; and
a third sensor (i) distinct from both the first sensor and the second sensor, and (ii) including a third output terminal, the third sensor being configured (i) to set the third output terminal to the first voltage level in response to the operable component being positioned at a third position, and (ii) to set the third output terminal to the second voltage level in response to the operable component being displaced from the third position, the third output terminal being coupled to the signal line through the third resistor, the third position being distinct from both the first position and the second position.
